(19) United States
(12) Patent Application Publication
(10) Pub. No.: US 2026/0043443 A1
(43) Pub. Date: Feb. 12, 2026

(54) Radially Actuated Drum Brake

(71) Applicant: KNORR-BREMSE Systeme fuer Nutzfahrzeuge GmbH, Muenchen (DE)

(72) Inventors: Frederic SCHROEPF, Deggendorf (DE); Johann Iraschko, Schweitenkirchen (DE); Ralf Weber, Munich (DE); Rudolf Fischer, Erding (DE); Abdelaziz Rguichi, Olching (DE); Michael Markl, Schoellnach (DE)

(21) Appl. No.: 19/293,183

(22) Filed: Aug. 7, 2025

(30) Foreign Application Priority Data
Aug. 8, 2024 (DE) 10 2024 122 653.6

(51) Int. Cl. F16D 51/14; F16D 121/04; F16D 127/02

(52) U.S. Cl. CPC F16D 51/14; F16D 2121/04; F16D 2127/02

(57) ABSTRACT

A radially actuated drum brake for a commercial vehicle has a brake drum, an anchor housing with bearing receptacles for brake linings, at least two brake linings, which are mounted in respective bearing receptacles in an accommodation space of the brake drum, each of the brake linings having a friction lining carrier, a friction lining arranged thereon, and a pressure piece, which is arranged on an underside of the lining carrier, the underside facing away from the friction lining, and protrudes radially in the direction of the rotational axis of the brake drum through an opening in the relevant bearing receptacle. An application device is arranged on a cylinder sleeve of the anchor housing and has at least one pressing part with which the brake linings can be pressed against an inner lateral face of the brake drum in an application direction radial to the rotational axis of the brake drum. In the accommodation space, there is provided on each of the brake linings at least one restoring spring, which is supported such that it bears against an underside of the bearing receptacle of the anchor housing, and with which the relevant brake lining can be moved from a braking position, bearing against the inner lateral face of the brake drum, into a non-braking position away from the inner lateral face of the brake drum.

### CROSS REFERENCE TO RELATED APPLICATION

This application claims priority under 35 U.S.C. § 119 from German Patent Application No. 10 2024 122 653.6, filed Aug. 8, 2024, the entire disclosure of which is herein expressly incorporated by reference.

### BACKGROUND AND SUMMARY

The invention relates to a radially actuated drum brake.

A drum brake of the type in question is known, for example, from DE 10 2021 115 785 B3. Such drum brakes generally have a cylindrical drum-shaped rotor, with friction surfaces arranged on an inner side of the rotor, which is also referred to as a brake drum. A braking force is generated using brake linings, which are pressed against the inner friction surface of the brake drum.

In the drum brakes of the type in question considered here, the force transmission of which is such that a force introduced axially to the rotational axis is intensified by its deflection such that the reaction force acts radially on the friction surface of the brake drum, the brake lining is pressed by means of a wedge that can be displaced in the direction of the rotational axis.

The reaction force can be divided by actuating multiple brake linings acting radially on the friction surface of the brake drum.

The force necessary for this is generated by a brake cylinder installed in the drum brake by supplying compressed air to a service brake piston of the brake cylinder and, as a result, displacing the wedge parallel to the rotational axis of the drum brake.

To release the brakes, the service brake piston is vented, and in the process the piston is displaced back in the direction of the original position owing to the elastic deformations in the system. If the elastic deformation is reduced, it can happen that the service piston and thus also the pressing wedge and the brake lining are not or not completely moved back into the non-braking position. That is, the brake linings are not actively removed from the inner lateral face of the drum, and therefore an undesirable residual grinding torque remains in the system.

The object of the present invention is to prevent such an undesirable residual grinding torque.

The stated object is achieved by a drum brake having the features of the independent claims.

The radially actuated drum brake according to the invention for a commercial vehicle has a brake drum, which is mounted rotatably about a rotational axis.

The drum brake also has an anchor housing with bearing receptacles for brake linings and at least two brake linings, which are mounted in respective bearing receptacles of the anchor housing in an accommodation space of the brake drum.

Each of the brake linings has a friction lining carrier, a friction lining arranged thereon, and a pressure piece, which is arranged on an underside of the lining carrier, said underside facing away from the friction lining, and protrudes radially in the direction of the rotational axis of the brake drum through an opening in the relevant bearing receptacle of the anchor housing.

The drum brake also has an application device, which is arranged on a cylinder sleeve of the anchor housing and has at least one pressing part with which the brake linings can be pressed against an inner lateral face of the brake drum in an application direction radial to the rotational axis of the brake drum.

In the accommodation space of the brake drum, there is provided on each of the brake linings at least one restoring spring, which is supported such that it bears against an underside of the bearing receptacle of the anchor housing, said underside facing away from the brake lining, and with which the relevant brake lining can be moved from a braking position, bearing against the inner lateral face of the brake drum, into a non-braking position away from the inner lateral face of the brake drum.

By providing such restoring springs, the occurrence of residual grinding torques is actively prevented in a reliable manner.

As a result, the fuel consumption of the commercial vehicle provided with such a drum brake can be reduced during driving, and the service life of the friction partners of brake drum and brake linings can be lengthened.

A further advantage of such restoring springs consists in being able to define a response pressure for activating the drum brake. Since the restoring springs are always installed with preloading, a predefined contact pressure is necessary to move the brake linings of the drum brake in the application direction.

Advantageous variants of the invention form the subject matter of the dependent claims.

According to an advantageous variant, the application device of the drum brake has a tapered ring, which can be displaced parallel to the rotational axis of the brake drum on the cylinder sleeve of the anchor housing, and a brake cylinder assembly, which is arranged in a rotationally fixed manner on the anchor housing in the accommodation space of the brake drum, for actuating the tapered ring.

When an application device designed in this way is used, the restoring springs also make it possible for the tapered ring and the piston of the brake cylinder to be moved back into their starting position (non-braking position) without the use of further spring elements.

According to an advantageous variant, the restoring spring is designed as a flat spring or as a corrugated spring.

According to a first variant, the restoring spring designed as a flat spring or as a corrugated spring is arranged in a preloaded manner between an underside of the bearing receptacle of the anchor housing, said underside facing away from the brake lining, and a face of the pressure piece, said face facing the underside of the bearing receptacle and extending perpendicularly to the application direction.

According to an advantageous development, the pressure piece has a neck piece, which is arranged on the underside of the lining carrier and extends through the opening in the relevant bearing receptacle of the anchor housing, and a pressing wedge, which is integrally formed on or fastened to the neck piece and sits on the tapered ring.

The flat spring or corrugated spring is supported on the face of the pressing wedge facing the underside of the bearing receptacle and extending perpendicularly to the application direction.

According to a preferred development, the flat spring or corrugated spring has supporting arms, which bear against the underside of the bearing receptacle.

According to a preferred development, the supporting arms bear slidingly against an underside of the bearing receptacle.

In a variant using corrugated springs, each corrugated spring bears in a stationary, clamped manner against the underside of the bearing receptacle.

Such a corrugated spring is characterized particularly preferably by a degressive spring characteristic, which can advantageously be used here, since the stroke of the corrugated spring is made possible by simple deformation of the corrugated spring. Sliding between the restoring spring and the anchor housing is not necessary here.

The degressive spring characteristic makes it possible for the force to overcome the spring force of the corrugated spring when applying the brake to be relatively small, in particular with larger application strokes, and thus the force loss required by the deformation of the corrugated spring can be kept small, which results overall in an improved efficiency of the drum brake.

According to a further alternative variant, in which a flat spring is arranged in each case between two adjacent brake linings, a first of the supporting arms of the flat spring bears in a preloaded manner against the face of the pressure piece of a first brake lining, said face facing the underside of the bearing receptacle and extending perpendicularly to the application direction, and a second of the supporting arms of the flat spring bears in a preloaded manner against the face of the pressure piece of a second brake lining, said face facing the underside of the bearing receptacle and extending perpendicularly to the application direction.

According to a further advantageous alternative embodiment of a drum brake according to the invention, at least one restoring spring is arranged between adjacent brake linings in the accommodation space of the brake drum, said restoring spring being fastened to the anchor housing and being designed as a flat spring with at least one supporting arm, wherein the at least one supporting arm bears in a preloaded manner against the side, carrying the friction lining, of the lining carrier of one of the brake linings.

In a preferred variant, the restoring spring is designed as a flat spring with two supporting arms, wherein a first of the supporting arms bears in a preloaded manner against the side, carrying the friction lining, of the lining carrier of a first brake lining, and a second of the supporting arms bears in a preloaded manner against the side, carrying the friction lining, of the lining carrier of an adjacent second brake lining.

These variants of the flat spring are preferably fastened via a retaining bolt, which is attached to the anchor housing.

According to a further alternative embodiment of a drum brake according to the invention, the restoring springs are designed as helical springs.

The helical springs are preferably arranged in a preloaded manner between an underside of the bearing receptacle of the anchor housing, said underside facing away from the brake lining, and a spring seat of the pressing wedge or of the pressure piece, said spring seat facing the underside of the bearing receptacle and extending perpendicularly to the application direction.

According to a further alternative variant of a drum brake according to the invention, the restoring spring is designed as a tension spring, which is preloaded between two adjacent brake linings and is preloaded between two adjacent brake linings such that it exerts a tensile restoring force on the brake linings when the brake linings have been applied.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic isometric view of a variant of a drum brake according to the invention;

FIG. 2 is a sectional view of the drum brake shown in FIG. 1 without showing the brake drum;

FIG. 3 is a sectional view of a detail of a first variant of a drum brake according to the invention with a restoring spring in the form of a flat spring between the housing and the pressing wedge;

FIG. 4 is a sectional view of a detail of a second variant of a drum brake according to the invention with a restoring spring in the form of a corrugated spring between the housing and the pressing wedge;

FIG. 5 is a sectional view of a detail of a third variant of a drum brake according to the invention with a restoring spring in the form of a helical spring between the housing and the pressing wedge;

FIG. 6 is a sectional view of a detail of a fourth variant of a drum brake according to the invention with flat springs fastened to the housing between two adjacent brake linings and resting laterally on the corresponding pressing wedge; and

FIG. 7 is a sectional view of a detail of a fifth variant of a drum brake according to the invention with flat springs fastened to the housing between two adjacent brake linings and resting laterally on the corresponding lining holder.

### DETAILED DESCRIPTION OF THE DRAWINGS

In the following description of the figures, terms such as upper, lower, left, right, front, rear etc. relate exclusively to the exemplary representation and position of the brake linings, drum brake, brake drum, pressure piece, restoring springs and the like selected in the respective figures. These terms are not to be understood as limiting, i.e., these relationships can change as a result of different working positions or the mirror-symmetrical layout or the like.

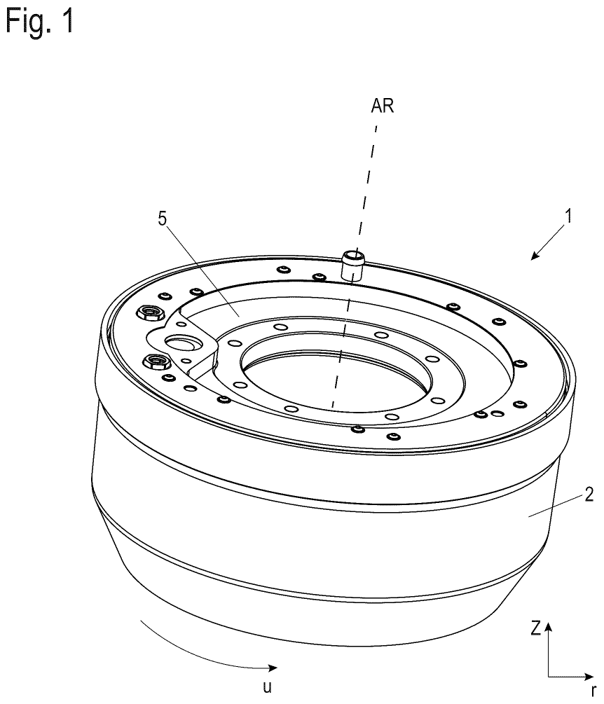

In FIG. 1, reference sign 1 denotes an embodiment of a drum brake according to the invention as a whole, in particular for use on a commercial vehicle.

The drum brake 1 has a brake drum 2, which is mounted rotatably about a rotational axis AR and is connected in a rotationally fixed manner to a hub of a wheel axle (not shown here) via an anchor housing 5.

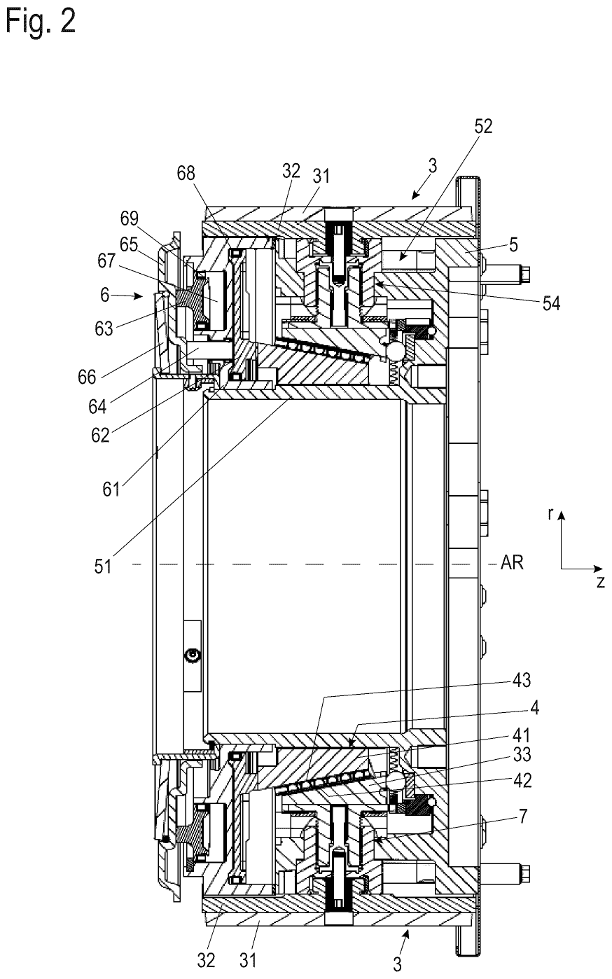

As shown in FIG. 2, according to a first variant, multiple brake linings 3 are arranged in an accommodation space inside the brake drum 2, each brake lining having a lining carrier 32 and a friction lining 31 arranged thereon. The brake linings 3 are arranged with their friction linings 31 facing an inner lateral face of the brake drum 2.

As also shown in FIG. 2, an application device 4 is arranged on the anchor housing 5, said application device having a tapered ring 41, which can be displaced parallel to the rotational axis AR of the brake drum 2 on a cylinder sleeve 51 of the anchor housing 5 and with which the brake linings 3 can be pressed against the inner lateral face, designed as a friction surface, of the brake drum 2 radially to the rotational axis AR of the brake drum 2 (direction r in FIG. 1).

To transmit the movement of the tapered ring 41 to the brake linings 3, in each case a pressing wedge 33 is arranged as part of a corresponding brake lining 3 on a side of the lining carrier 32 facing away from the friction lining 31.

A pressure piece 7 is arranged between the pressing wedge 33 and the lining carrier 32. The pressure piece 7 is held on the lining carrier 32 form-fittingly and/or frictionally in the radial direction.

The pressing wedge 33 rests on a contact face of the tapered ring 41.

The tapered ring 41 is preferably displaceable in a direction z from a non-braking position into a braking position parallel to the rotational axis AR of the brake drum 2 via a service brake piston 62 of a brake cylinder assembly 6.

A slide 42 with multiple rolling elements 43 is arranged between the tapered ring 41 and the pressing wedge 33 of the brake lining 3 to reduce the friction between the contact face of the tapered ring 41 and the pressing wedge 33 of the brake lining 3.

The brake cylinder assembly 6, as a component of the application device 4, is used to execute the radial pressing movement of the brake shoes 3 against the inner lateral face of the brake drum 2.

The brake cylinder assembly 6 has a housing 61, which is fastened to the anchor housing 5 in a stationary manner in the accommodation space of the brake drum 2.

Relative to this housing 61, the service brake piston 62 is arranged displaceably parallel to the rotational axis AR of the brake drum 2.

The brake cylinder assembly 6 also has a parking brake piston 63, which is displaceable relative to the housing 61 parallel to the rotational axis AR of the brake drum 2 and to which the spring force of a spring element 66, preferably in the form of a spring washer, can be applied via an intermediate plate 65.

The brake cylinder assembly 6 also has multiple tappets 64, which are used to transmit a movement of the parking brake piston 63 to the service brake piston 62.

Furthermore, compressed air supplies are provided, which open firstly into a service brake pressure space between the housing 61 and the service brake piston 62 and secondly into a parking brake pressure space 67 between the housing 61 and the parking brake piston 63.

The movement of the service brake piston 62 is always important for the actuation of the brake shoes 3 and is effected, when the speed of the commercial vehicle is to be reduced, a so-called service brake operation, by supplying compressed air into the service brake pressure space.

When the brake that is used to prevent the commercial vehicle from inadvertently rolling away in a parking situation is to be secured, compressed air present in the parking brake pressure space 67 during driving is let out of the parking brake pressure space 67, which results in displacement of the parking brake piston 63 in the direction of the service brake piston 62. The displacement is caused by the spring element 66 exerting force on a rear side of the parking brake piston 63 facing away from the service brake piston 62.

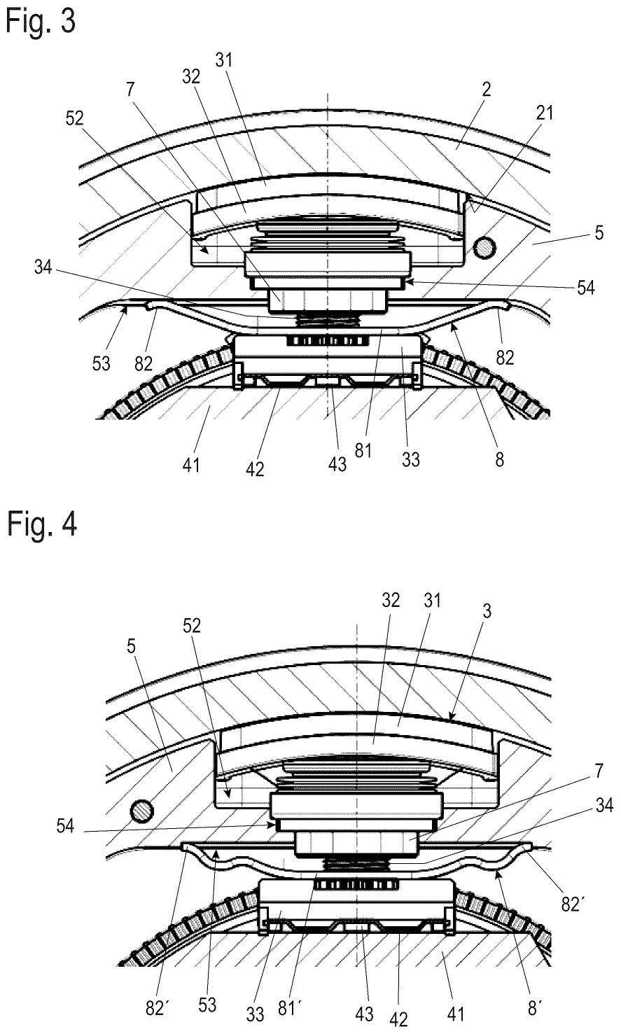

As shown in FIGS. 3 to 7, the brake linings 3 are each mounted in bearing receptacles 52 of the anchor housing 5.

Each of the bearing receptacles 52 has an opening through which the pressure piece 7 protrudes radially in the direction of the rotational axis AR of the brake drum 2.

Alternatively to the application device 4 with the tapered ring 41 and the brake cylinder assembly 6 arranged in a rotationally fixed manner on the anchor housing 5 in the accommodation space 22 of the brake drum 2 for actuating the tapered ring 41, it is also contemplated in principle to provide an application device with at least one pressing part with which the brake linings 3 can be pressed against an inner lateral face 21 of the brake drum 2 in an application direction r radial to the rotational axis AR of the brake drum 2.

As also shown in FIGS. 3 to 7, in the accommodation space of the brake drum 2, there is provided on each of the brake linings 3 at least one restoring spring, which is supported such that it bears against an underside 53 of the bearing receptacle 52 of the anchor housing 5, said underside facing away from the brake lining 3, and with which the relevant brake lining 3 can be moved from a braking position, bearing against the inner lateral face 21 of the brake drum 2, into a non-braking position away from the inner lateral face 21 of the brake drum 2.

FIGS. 3 to 7 each show different variants of such restoring springs or arrangements of restoring springs in the accommodation space of the brake drum 2.

A further advantage of such restoring springs consists in being able to define a response pressure for activating the drum brake. Since the restoring springs are always installed with preloading, a predefined contact pressure is necessary to move the brake linings of the drum brake in the application direction.

Such a response pressure is preferably between 0.15 bar and 0.25 bar, in particular 0.2 bar.

In the variant shown in FIG. 3, the restoring spring is designed as a flat spring 8. In this variant, it is sufficient to provide exactly one such flat spring 8 for each brake lining 3. The flat spring 8 has a first supporting face 81, from which supporting arms 82 extend on both sides.

The flat spring 8 is arranged in a preloaded manner between an underside 53 of the bearing receptacle 51 of the anchor housing 5, said underside facing away from the brake lining 3, and a face of the pressing wedge 33, said face facing the underside 53 of the bearing receptacle 51 and extending perpendicularly to the application direction r. For this purpose, the supporting face 81 rests on the face of the pressing wedge 33 facing the underside 53 of the bearing receptacle 51 and extending perpendicularly to the application direction r. The supporting arms 82 bear against the underside 53 of the bearing receptacle 51.

It is in principle also contemplated to design the pressure piece 7 with such a rest face for supporting the first supporting face 81 of the flat spring 8. It is important that the brake lining 3 is moved away from the inner lateral face 21 of the brake drum 2 by the preloaded restoring spring after the end of a braking stroke in which the brake lining 3 was pressed against the inner lateral face 21 of the brake drum 2. This is made possible in principle by supporting the first supporting face 81 of the flat spring 8 on a face of a component of the brake lining 3 that is connected fixedly to the friction lining 31, said face facing the underside 53 of the bearing receptacle 51 on which the supporting arms 82 are supported.

The supporting arms 82 of the flat spring 8 bearing against the underside 53 of the bearing receptacle 51 can slide along the underside 53 of the bearing receptacle 51 when the brake lining 3 is pressed against the brake drum 2, wherein the length of the flat spring 8, viewed in the circumferential direction of the brake drum, is enlarged by deformation of the flat spring 8.

In the alternative variant shown in FIG. 4, a corrugated spring 8′ is used instead of the flat spring 8. This corrugated spring 8′ is mounted at the same point as the flat spring 8 described using FIG. 3.

In contrast to the variant according to FIG. 3, the supporting arms 82′ of the corrugated spring 8′ are not applied slidably to the underside 53 of the bearing receptacle 51 but are clamped in a stationary manner to the underside 53 of the bearing receptacle 51.

During a braking stroke, the corrugated spring 8′ is deformed such that a longitudinal extension in the circumferential direction of the brake drum does not take place here.

A particular advantage of the use of such a corrugated spring 8′ lies in an advantageous degressive spring characteristic of the corrugated spring 8′, in which the spring rate, unlike the flat spring 8, does not increase linearly, so that the force to overcome the spring force when the brake is applied is relatively low, in particular with larger application strokes, and as a result a smaller force is needed to overcome the spring force.

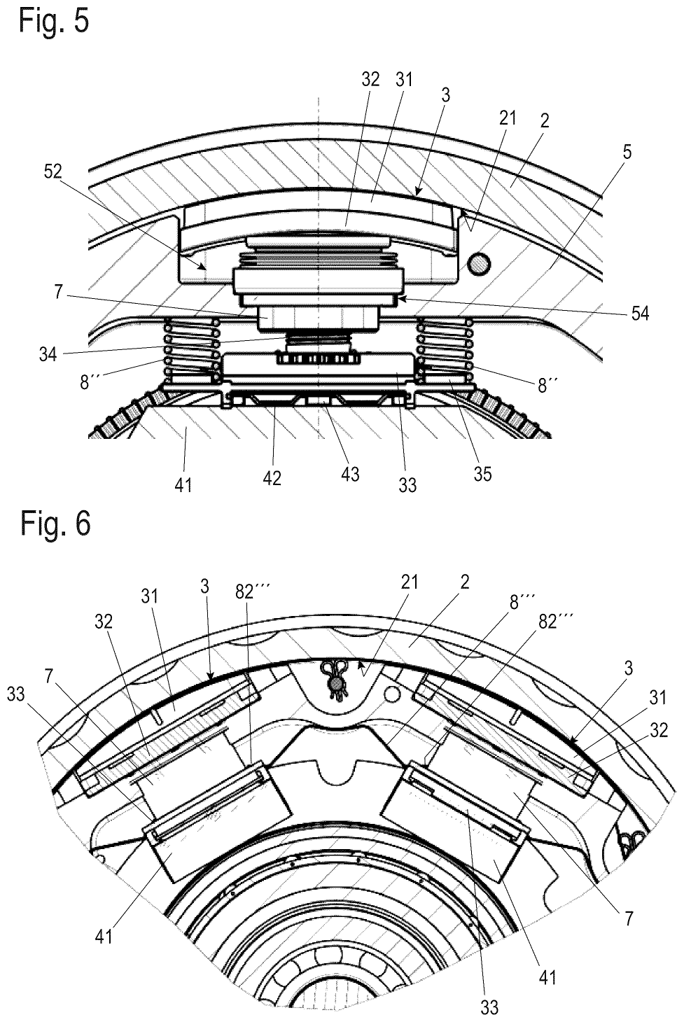

In the further alternative variant of a drum brake according to the invention shown in FIG. 5, on the pressing wedge 33 at least one spring seat 35 is integrally formed on the pressing wedge 33.

This allows the use of at least one restoring spring designed as a helical spring 8″. In the exemplary embodiment shown, two such helical springs 8″ are provided per brake lining 3.

It is also contemplated here to provide such a spring seat 35 on an alternatively designed pressure piece 7, on which the helical springs 8″ can be supported relative to the underside 53 of the bearing receptacle 51 of the anchor housing 5.

In the further variant shown in FIG. 6, a flat spring 8′″ is used again. In this case, the flat spring 8′″ is fastened to the anchor housing 5 between two adjacent brake linings 3. To fix the flat spring on the anchor housing 5, a retaining bolt 9, which is secured in the anchor housing 5 for example by a securing cotter pin 91, is preferably used.

Here, a first of the supporting arms 82′″ of the flat spring 8′″ is applied in a preloaded manner to the face of the pressing wedge 33 of the pressure piece 7, said face facing the underside 53 of the bearing receptacle 51 and extending perpendicularly to the application direction r, and a second of the supporting arms 82′″ of the flat spring 8′″ is applied in a preloaded manner to the face of the pressure piece 7 of a second brake lining 3, said face facing the underside 53 of the bearing receptacle 51 and extending perpendicularly to the application direction r.

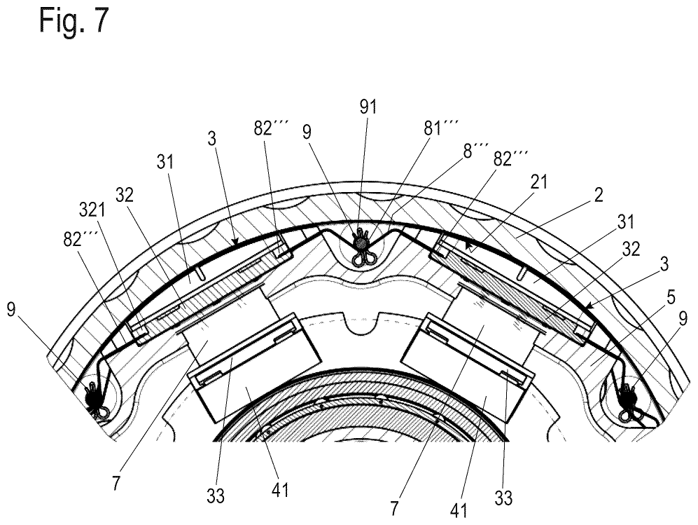

In the variant of a drum brake according to the invention shown in FIG. 7, a flat spring 8′″ is provided again, which is fastened to the anchor housing 5 via a retaining bolt 9. The flat spring 8′″ in this case is positioned such that a first of the supporting arms 82′″ bears in a preloaded manner against the side, carrying the friction lining 31, of the lining carrier 32 of a first brake lining 3, and a second of the supporting arms 82′″ bears in a preloaded manner against the side, carrying the friction lining 31, of the lining carrier 32 of an adjacent second brake lining 3.

Also contemplated is a flat spring 8′″ with only one supporting arm 82′″, which is fastened to the anchor housing 5 via a retaining bolt 9 and in which the supporting arm 82′″ bears in a preloaded manner against the side, carrying the friction lining 31, of the lining carrier 32 of only one of the brake linings 3. It is also contemplated that two such flat springs 8′″ with only one supporting arm 82′″ are fastened to the same retaining bolt 9 on the anchor housing 5.

Instead of the flat spring 8′″ acting here as compression springs, it is also contemplated to use tension springs, which are inserted between adjacent brake linings 3 and firstly are likewise fastened to the anchor housing 5 via a retaining bolt 9 and secondly are firmly fixed to adjacent brake linings 3. These tension springs are tensioned when the brake is applied. After the end of the braking process, the tension springs then pull the brake linings 3 back into their non-braking position and thus likewise reliably prevent residual grinding torques.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A radially actuated drum brake for a commercial vehicle, comprising:
a brake drum, which is mountable rotatably about a rotational axis;
an anchor housing with bearing receptacles for brake linings;
at least two brake linings, which are mounted in respective ones of the bearing receptacles of the anchor housing in an accommodation space of the brake drum;
each of the brake linings having a friction lining carrier, a friction lining being arranged thereon, and a pressure piece, which is arranged on an underside of the lining carrier, said underside facing away from the friction lining, the pressure piece protruding radially in a direction of the rotational axis of the brake drum through an opening in an associated bearing receptacle of the anchor housing;
an application device, which is arranged on a cylinder sleeve of the anchor housing and has at least one pressing part with which the brake linings are pressable against an inner lateral face of the brake drum in an application direction radial to the rotational axis of the brake drum; and
at least one restoring spring, in the accommodation space of the brake drum, on each of the brake linings, which at least one restoring spring is supported so as to bear against an underside of the bearing receptacle of the anchor housing, said underside facing away from the brake lining, and with which the associated brake lining is movable from a braking position, bearing against the inner lateral face of the brake drum, into a non-braking position away from the inner lateral face of the brake drum.

2. The drum brake as claimed in claim 1, wherein the application device further comprises:
a tapered ring, which is displaceable parallel to the rotational axis of the brake drum on the cylinder sleeve of the anchor housing, and
a brake cylinder assembly, which is arranged in a rotationally fixed manner on the anchor housing in the accommodation space of the brake drum, for actuating the tapered ring.

3. The drum brake as claimed in claim 2, wherein the restoring spring is a flat spring or a corrugated spring.

4. The drum brake as claimed in claim 3, wherein
the restoring spring configured as the flat spring or the corrugated spring is arranged in a pre-loaded manner between the underside of the bearing receptacle of the anchor housing, said underside facing away from the brake lining, and a face of the pressure piece, said face facing the underside of the bearing receptacle and extending perpendicularly to the application direction.

5. The drum brake as claimed in claim 3, wherein
the pressure piece has a neck piece, which is arranged on the underside of the lining carrier and extends through the opening in the associated bearing receptacle of the anchor housing, and a pressing wedge, which is integrally formed on or fastened to the neck piece and sits on the tapered ring,
the flat spring or the corrugated spring is supported on the face of the pressing wedge facing the underside of the bearing receptacle and extending perpendicularly to the application direction.

6. The drum brake as claimed in claim 3, wherein
the flat spring or the corrugated spring has supporting arms, which bear against the underside of the bearing receptacle.

7. The drum brake as claimed in claim 6, wherein the supporting arms bear slidably against the underside of the bearing receptacle.

8. The drum brake as claimed in claim 6, wherein the corrugated spring bears in a stationary, clamped manner against the underside of the bearing receptacle.

9. The drum brake as claimed in claim 3, wherein
a first supporting arm of the flat spring is applied in a preloaded manner to the face of the pressure piece of a first brake lining, said face facing the underside of the bearing receptacle and extending perpendicularly to the application direction, and
a second supporting arm of the flat spring is applied in a preloaded manner to the face of the pressure piece of a second brake lining, said face facing the underside of the bearing receptacle and extending perpendicularly to the application direction.

10. The drum brake as claimed in claim 1, wherein the restoring spring is a helical spring.

11. The drum brake as claimed in claim 10, wherein
the helical spring is arranged in a preloaded manner between an underside of the bearing receptacle of the anchor housing, said underside facing away from the brake lining, and a spring seat of the pressing wedge or of the pressure piece, said spring seat facing the underside of the bearing receptacle and extending perpendicularly to the application direction.

12. The drum brake as claimed in claim 1, wherein
the restoring spring is a tension spring, which is preloaded between two adjacent brake linings so as to exert a tensile restoring force on the brake linings when the brake linings have been applied.

13. A radially actuated drum brake for a commercial vehicle, comprising:
a brake drum, which is mountable rotatably about a rotational axis;
an anchor housing with bearing receptacles for brake linings;
at least two brake linings, which are mounted in respective ones of the bearing receptacles of the anchor housing in an accommodation space of the brake drum;
each of the brake linings having a friction lining carrier, a friction lining arranged thereon, and a pressure piece, which is arranged on an underside of the lining carrier, said underside facing away from the friction lining, the pressure piece protruding radially in a direction of the rotational axis of the brake drum through an opening in an associated bearing receptacle of the anchor housing;
an application device, which is arranged on a cylinder sleeve of the anchor housing and has at least one pressing part with which the brake linings are pressable against an inner lateral face of the brake drum in an application direction radial to the rotational axis of the brake drum; and
at least one restoring spring arranged between adjacent brake linings in the accommodation space of the brake drum, said restoring spring being designed as a flat spring that is fastened to the anchor housing and has at least one supporting arm, the at least one supporting arm bearing in a preloaded manner against the side, carrying the friction lining, of the lining carrier of one of the brake linings.

14. The drum brake as claimed in claim 13, wherein
the restoring spring is designed as a flat spring that is fastened to the anchor housing and has two supporting arms, a first of the supporting arms bearing in a preloaded manner against the side, carrying the friction lining, of the lining carrier of a first brake lining, and a second of the supporting arms bearing in a preloaded manner against the side, carrying the friction lining, of the lining carrier of an adjacent sec-ond brake lining.
